(19) United States
(12) Patent Application Publication
(10) Pub. No.: US 2023/0297884 A1
(43) Pub. Date: Sep. 21, 2023

(54) Handling Training of a Machine Learning Model

(71) Applicant: Telefonaktiebolaget LM Ericsson (PUBL), Stockholm (SE)

(72) Inventors: Athanasios Karapantelakis, SOLNA (SE); Ioannis Fikouras, STOCKHOLM (SE); Lackis Eleftheriadis, VALBO (SE); Marios Daoutis, Bromma (SE); Maxim Teslenko, SOLLENTUNA (SE); Akis Laftsidis, Sundbyberg (SE); Alexandros Nikou, Stockholm (SE); Konstantinos Vandikas, SOLNA (SE)

(21) Appl. No.: 18/021,412

(22) PCT Filed: Aug. 18, 2020
(86) PCT No.: PCT/EP2020/073136

§ 371 Date: Feb. 15, 2023

(51) Int. Cl. G06N 20/00

(52) U.S. Cl. CPC G06N 20/00

(57) ABSTRACT

There is provided a method for handling training of a machine learning model. The method is performed by a coordinating entity that is operable to coordinate the training of the machine learning model at one or more network nodes. In response to receiving a request to train the machine learning model, a first network node is selected (402), from a plurality of network nodes, to train the machine learning model based on information indicative of a performance of each of the plurality of network nodes and/or information indicative of a quality of a network connection to each of the plurality of network nodes. Transmission of the machine learning model is initiated (404) towards the first network node for the first network node to train the machine learning model.

### TECHNICAL FIELD

The disclosure relates to a method for handling training of a machine learning model and an entity configured to operate in accordance with that method.

### BACKGROUND

In machine learning, incremental learning is a basic method where learning is performed when new data becomes available over time. In contradiction to traditional learning practices, where a model is trained and then used, incremental learning has the advantage of on-line (life-long) learning, whereby models become increasingly accurate and/or expand their functionality (e.g. having more classes in classification models), as new data becomes available.

As an example, one popular application of incremental learning is training convolutional neural networks for object detection. Typically, a dataset comprising common objects is used to pre-train a baseline model. Given a baseline model, a user can supply their own dataset of objects and start training using this new dataset using the baseline model. All the “feature extraction” layers of the baseline model are used with the exception of the last classification layers, which classify the objects of the user, rather than those of the baseline dataset. Since the feature extraction layers are pre-trained, they become better at detecting basic shape and thus, when used in this context, incremental learning increases the accuracy of the model.

Incremental learning is suitable for cases where training data is not readily available but may become available later. In third generation parentship project (3GPP) networks, and especially the radio access network (RAN), a number of use cases exist around models that are used in radio base stations. In these use cases, the models are trained partially or exclusively on input data from user equipments (UEs) and configuration information of the radio base station. The configuration information may be, for example, radio access technology, bandwidth, power source, model of baseband/radio unit/antenna, etc. Some examples of these models include data traffic prediction models, power consumption optimization models for the radio unit, UE handover models, etc.

The mobile network, with its user-data rich and distributed RAN, represents an ideal candidate for building models that focus on decision support for RAN using incremental learning, since every cell can contribute to a richer dataset due to its different configuration and/or different UE behaviour. It is particularly important in these distributed networks to assess the accuracy of the trained model. Generally, in existing techniques for incremental learning, the accuracy of the trained model is assessed using a reference dataset that is a priori determined. However, in dynamic environments, such as mobile networks, obtaining reliable test data to assess the model beforehand can be challenging, since different radio base stations will have UEs that exhibit different behaviour.

In addition, existing techniques that use incremental learning do not take into account the transient computational availability of network nodes, as they always assume an overabundant or omnipresent compute capability. However, the primary goal of network nodes is to accommodate mobile connectivity and not to train models, which means that mobile connectivity will always be prioritised over training models.

### SUMMARY

It is thus an object of the disclosure to obviate or eliminate at least some of the above-described disadvantages associated with existing techniques.

Therefore, according to an aspect of the disclosure, there is provided a method for handling training of a machine learning model. The method is performed by a coordinating entity that is operable to coordinate the training of the machine learning model at one or more network nodes. The method is performed in response to receiving a request to train the machine learning model. The method comprises selecting, from a plurality of network nodes, a first network node to train the machine learning model based on information indicative of a performance of each of the plurality of network nodes and/or information indicative of a quality of a network connection to each of the plurality of network nodes. The method also comprises initiating transmission of the machine learning model towards the first network node for the first network node to train the machine learning model.

In this way, the coordinating entity can use existing (e.g. mobile) network infrastructure and interfaces to handle the training of a machine learning model. This can be particularly advantageous as it means that the technique can function during network operation, e.g. opportunistically taking advantage of excess compute capacity when available. Moreover, the first network node can be selected as the network node that provides the best performance and quality, such that an efficient and reliable training of the machine learning model can be assured.

In some embodiments, the machine learning model may be a previously untrained machine learning model or a machine learning model previously trained by another network node of the plurality of network nodes.

In some embodiments, the method may comprise, in response to receiving the trained machine learning model from the first network node, checking whether the trained machine learning model meets a predefined threshold for one or more performance metrics.

In some embodiments, checking whether the trained machine learning model meets a predefined threshold for one or more performance metrics may comprise comparing an output of the machine learning model resulting from the input of reference data into the machine learning model to an output of the trained machine learning model resulting from an input of the same reference data into the trained machine learning model, and analysing a difference in the outputs to check whether the trained machine learning model meets the predefined threshold for the one or more performance metrics. In this way, the training of the machine learning model can be verified.

In some embodiments, the method may comprise updating a reputation index for the first network node based on the difference in the outputs, wherein the reputation index for the first network node may be a measure of the effectiveness of the first network node in training machine learning models compared to other network nodes of the plurality of network nodes.

In some embodiments, the method may comprise determining whether to add training data, used by the first network node to train the machine learning model, to the reference data based on the difference in the outputs.

In some embodiments, the method may comprise, in response to determining the training data is to be added to the reference data, initiating transmission of a request for the training data towards the first network node and, in response to receiving the training data, adding the training data to the reference data.

In some embodiments, the method may comprise, in response to the first network node completing the training of the machine learning model, or in response to a failure of the first network node to train the machine learning model, selecting, from the plurality of network nodes, a second network node to further train the trained machine learning model based on information indicative of a performance of each of the plurality of network nodes and/or information indicative of a quality of a network connection to each of the plurality of network nodes. In these embodiments, the first network node and the second network node may be different network nodes. In some of these embodiments, the method may comprise initiating transmission of a request towards the second network node to trigger a transfer of the trained machine learning model from the first network node to the second network node for the second network node to further train the machine learning model. There is thus provided a method for distributing incremental training for a machine learning model across a plurality of network nodes. In this way, the technique can provide richer data, which can result in machine learning models with greater variance and/or less bias than those that are independently trained at every network node.

In some embodiments, the method may comprise, if the trained machine learning model fails to meet the one or more performance metrics, selecting the second network node to further train the trained machine learning model and initiating the transmission of the request towards the second network node to trigger the transfer. In some embodiments, the method may comprise, if the trained machine learning model meets the one or more performance metrics, initiating transmission of the trained machine learning model towards an entity that initiated transmission of the request to train the machine learning model.

In some embodiments, selecting the second network node may be in response to receiving the trained machine learning model from the first network node.

In some embodiments, the method may be repeated in respect of at least one other different network node of the plurality of network nodes.

In some embodiments, the information indicative of the performance of each of the plurality of network nodes may comprise information indicative of a past performance of each of the plurality of network nodes and/or information indicative of an expected performance of each of the plurality of network nodes.

In some embodiments, the information indicative of the past performance of each of the plurality of network nodes may comprise a measure of a past effectiveness of each of the plurality of network nodes in training machine learning models, and/or the information indicative of the expected performance of each of the plurality of network nodes may comprise a measure of an available compute capacity of each of the plurality of network nodes and/or a measure of the quality and/or an amount of training data available to each of the plurality of network nodes.

In some embodiments, the information indicative of the quality of the network connection to each of the plurality of network nodes may comprise a measure of an available throughput of the network connection to each of the plurality of network nodes, a measure of a latency of the network connection to each of the plurality of network nodes, and/or a measure of a reliability of the network connection to each of the plurality of network nodes.

According to another aspect of the disclosure, there is provided a coordinating entity comprising processing circuitry configured to operate in accordance with the method described earlier. The coordinating entity thus provides the advantages described earlier. In some embodiments, the coordinating entity may comprise at least one memory for storing instructions which, when executed by the processing circuitry, cause the coordinating entity to operate in accordance with the method described earlier.

According to another aspect of the disclosure, there is provided a method for handling training of machine learning model, wherein the method is performed by a system. The system comprises a plurality of network nodes and a coordinating entity that is operable to coordinate training of the machine learning model at one or more of the plurality of network nodes. The method comprises the method described earlier a method performed by the first network node. The method performed by the first network node comprises, in response to receiving the machine learning model from the coordinating entity, training the machine learning model using training data that is available to the first network node.

In some embodiments, the method performed by the first network node may comprise continuing to train the machine learning model using the training data that is available to the first network node until a maximum accuracy for the trained machine learning model is reached and/or until the first network node runs out of computational capacity to train the machine learning model. In this way, the machine learning model can be trained by a network node until the maximum accuracy is achieved to thereby provide the most accurate machine learning model possible.

In some embodiments, the method performed by the first network node may comprise, in response to receiving a request for the training data, wherein transmission of the request is initiated by the coordinating entity, initiating transmission of the training data towards the coordinating entity.

In some embodiments, the method performed by the first network node may comprise initiating transmission of the trained machine learning model towards the coordinating entity.

In some embodiments, the method performed by the first network node may comprise, in response to receiving a request to trigger a transfer of the trained machine learning model from the first network node to the second network node, initiating the transfer of the trained machine learning model from the first network node to the second network node for the second network node to further train the machine learning model.

In some embodiments, the training data that is available to the first network node may comprise data from one or more devices registered to the first network node.

According to another aspect of the disclosure, there is provided a system comprising the coordinating entity as described earlier. The system comprises a plurality of network nodes. The plurality of network nodes comprise at least one first network node comprising processing circuitry configured to operate in accordance with the method described earlier in respect of the first network node. The system thus provides the advantages described earlier.

According to another aspect of the disclosure, there is provided a computer program comprising instructions which, when executed by processing circuitry, cause the processing circuitry to perform the method described earlier. The computer program thus provides the advantages described earlier.

According to another aspect of the disclosure, there is provided a computer program product, embodied on a non-transitory machine-readable medium, comprising instructions which are executable by processing circuitry to cause the processing circuitry to perform the method described earlier. The computer program product thus provides the advantages described earlier.

Therefore, advantageous techniques for handling training of a machine learning model are provided.

### BRIEF DESCRIPTION OF THE DRAWINGS

For a better understanding of the techniques, and to show how they may be put into effect, reference will now be made, by way of example, to the accompanying drawings, in which:

FIG. 1 is a schematic illustrating a system according to an embodiment;

FIG. 2 is a block diagram illustrating a coordinating entity according to an embodiment;

FIG. 3 is a flowchart illustrating a method performed by a coordinating entity according to an embodiment;

FIG. 4 is a block diagram illustrating a first network node according to an embodiment;

FIG. 5 is a flowchart illustrating a method performed by a first network node according to an embodiment;

FIG. 6A-D is a signalling diagram illustrating an exchange of signals in a system according to an embodiment;

FIG. 7 is a block diagram illustrating a coordinating entity according to an embodiment; and

FIG. 8 is a block diagram illustrating a first network node according to an embodiment.

### DETAILED DESCRIPTION

As mentioned earlier, advantageous techniques for handling training of a machine learning model are described herein.

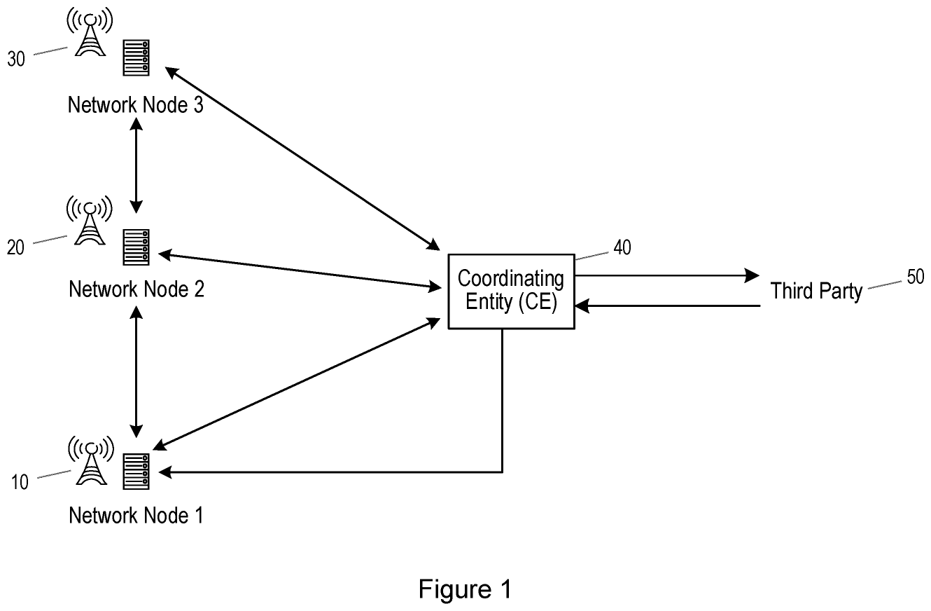

FIG. 1 is a block diagram illustrating a system in accordance with an embodiment. The system illustrated in FIG. 1 comprises a plurality of network nodes 10, 20, 30. The plurality of network nodes 10, 20, 30 comprises a first network node 10, a second network node 20, and a third network node 30. However, it will be understood that the system may comprise any other number of network nodes. The network nodes 10, 20, 30 are nodes of a network. In some embodiments, the network can be a mobile network. The network can be a fifth generation (5G) network, or any other generation network. In some embodiments, the network may be a radio access network (RAN), or any other type of network.

The system illustrated in FIG. 1 comprises a coordinating entity 40. The technique described herein is implemented by the coordinating entity 40. The technique is implemented in response to (or triggered by) receiving a request to train a machine learning model. The request may, for example, be from another entity 50, which may be referred to herein as a third party entity as it can be external to the system. There may be more than one third party entity 50 and the technique described herein can be implemented each time a request from any one of these third party entities 50 is received. In a 3GPP implementation, the third party entity 50 can be an application function, which is a node that is external to the mobile network. The third party entity 50 may be a user device according to some embodiments. The coordinating entity 40 has two interfaces. Specifically, the coordinating entity 40 has a “northbound” interface towards the third party entity 50 and a “southbound” interface towards the network nodes 10, 20, 30. The northbound interface can accept a request (or any number of requests) to train a machine learning model.

In some embodiments, a request to train a machine learning model can comprise a description of the machine learning model to be trained. The description may, for example, comprise a structure of the machine learning model to be trained. For example, in embodiments where the machine learning model is in the form of a neural network, the description of the machine learning model may be the number of layers, the number of neurons in each layer, and/or an activation function of each neuron.

In some embodiments, the request to train a machine learning model may comprise one or more performance metrics (e.g. a performance metric or a set of performance metrics) and a predefined threshold for the one or more performance metrics. The one or more performance metrics are one or more metrics on the performance of the machine learning model and the predefined threshold for the one or more performance metrics is a threshold that is acceptable, e.g. to the third party 50 from which the request is received. A typical universal metric for classification models is accuracy but, alternatively or additionally, there can be one or more other metrics and this may depend on the machine learning model.

In some embodiments, the request to train a machine learning model may comprise reference data (or a reference dataset). The reference data can be data against which the one or more performance metrics can be calculated, e.g. each time the machine learning model is trained. The reference data can be used to verify training in this way. In some embodiments, depending on the result of the one or more performance metrics, the reference data may be enriched with data from the training of the model.

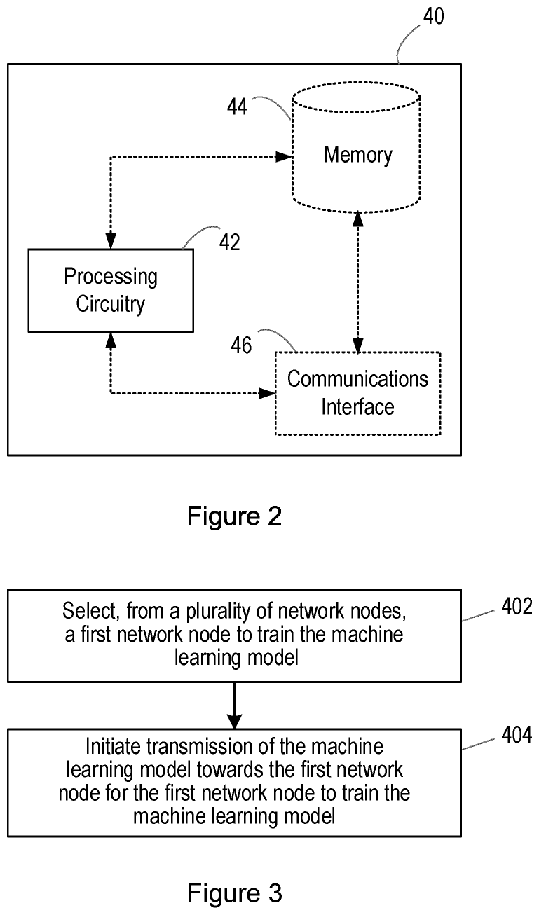

FIG. 2 illustrates the coordinating entity 40 in accordance with an embodiment. The coordinating entity 40 is for handling training of a machine learning model. The coordinating entity 40 is operable to coordinate the training of the machine learning model at one or more network nodes.

The coordinating entity 40 may, for example, be a physical machine (e.g. a server) or a virtual machine (VM). In some embodiments, the coordinating entity 40 may be a logical node. In a 3GPP implementation, the coordinating entity 40 may be a network data analytics function (NWDAF) node. In some embodiments, the coordinating entity 40 may be comprised in a network node (such as any of the network nodes 10, 20, 30 mentioned herein). In a RAN implementation, the coordinating entity 40 may be comprised in a RAN node or cell. Thus, the coordinating entity 40 can be internal to the network according to some embodiments. In other embodiments, the coordinating entity 40 may be external to the network. For example, the coordinating entity 40 may be hosted in a (e.g. public) cloud.

As illustrated in FIG. 2, the coordinating entity 40 comprises processing circuitry (or logic) 42. The processing circuitry 42 controls the operation of the coordinating entity 40 and can implement the method described herein in respect of the coordinating entity 40. The processing circuitry 42 can be configured or programmed to control the coordinating entity 40 in the manner described herein. The processing circuitry 42 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the coordinating entity 40. In some embodiments, the processing circuitry 42 can be configured to run software to perform the method described herein in respect of the coordinating entity 40. The software may be containerised according to some embodiments. Thus, in some embodiments, the processing circuitry 42 may be configured to run a container to perform the method described herein in respect of the coordinating entity 40.

Briefly, the processing circuitry 42 of the coordinating entity 40 is configured to, in response to receiving a request to train the machine learning model, select, from a plurality of network nodes, a first network node to train the machine learning model based on information indicative of a performance of each of the plurality of network nodes and/or information indicative of a quality of a network connection to each of the plurality of network nodes. The processing circuitry 42 of the coordinating entity 40 is configured to initiate transmission of the machine learning model towards the first network node for the first network node to train the machine learning model.

As illustrated in FIG. 2, in some embodiments, the coordinating entity 40 may optionally comprise a memory 44. The memory 44 of the coordinating entity 40 can comprise a volatile memory or a non-volatile memory. In some embodiments, the memory 44 of the coordinating entity 40 may comprise a non-transitory media. Examples of the memory 44 of the coordinating entity 40 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 42 of the coordinating entity 40 can be connected to the memory 44 of the coordinating entity 40. In some embodiments, the memory 44 of the coordinating entity 40 may be for storing program code or instructions which, when executed by the processing circuitry 42 of the coordinating entity 40, cause the coordinating entity 40 to operate in the manner described herein in respect of the coordinating entity 40. For example, in some embodiments, the memory 44 of the coordinating entity 40 may be configured to store program code or instructions that can be executed by the processing circuitry 42 of the coordinating entity 40 to cause the coordinating entity 40 to operate in accordance with the method described herein in respect of the coordinating entity 40. Alternatively or in addition, the memory 44 of the coordinating entity 40 can be configured to store any information, data, messages, requests, responses, indications, notifications, signals, or similar, that are described herein. The processing circuitry 42 of the coordinating entity 40 may be configured to control the memory 44 of the coordinating entity 40 to store information, data, messages, requests, responses, indications, notifications, signals, or similar, that are described herein.

In some embodiments, as illustrated in FIG. 2, the coordinating entity 40 may optionally comprise a communications interface 46. The communications interface 46 of the coordinating entity 40 can be connected to the processing circuitry 42 of the coordinating entity 40 and/or the memory 44 of coordinating entity 40. The communications interface 46 of the coordinating entity 40 may be operable to allow the processing circuitry 42 of the coordinating entity 40 to communicate with the memory 44 of the coordinating entity and/or vice versa. Similarly, the communications interface 46 of the coordinating entity 40 may be operable to allow the processing circuitry 42 of the coordinating entity to communicate with any one or more of the plurality of network nodes 10, 20, 30, and/or any other node described herein. The communications interface 46 of the coordinating entity 40 can be configured to transmit and/or receive information, data, messages, requests, responses, indications, notifications, signals, or similar, that are described herein. In some embodiments, the processing circuitry 42 of the coordinating entity 40 may be configured to control the communications interface 46 of the coordinating entity 40 to transmit and/or receive information, data, messages, requests, responses, indications, notifications, signals, or similar, that are described herein.

Although the coordinating entity 40 is illustrated in FIG. 2 as comprising a single memory 44, it will be appreciated that the coordinating entity 40 may comprise at least one memory (i.e. a single memory or a plurality of memories) 44 that operate in the manner described herein. Similarly, although the coordinating entity 40 is illustrated in FIG. 2 as comprising a single communications interface 46, it will be appreciated that the coordinating entity 40 may comprise at least one communications interface (i.e. a single communications interface or a plurality of communications interface) 46 that operate in the manner described herein. It will also be appreciated that FIG. 2 only shows the components required to illustrate an embodiment of the coordinating entity 40 and, in practical implementations, the coordinating entity 40 may comprise additional or alternative components to those shown.

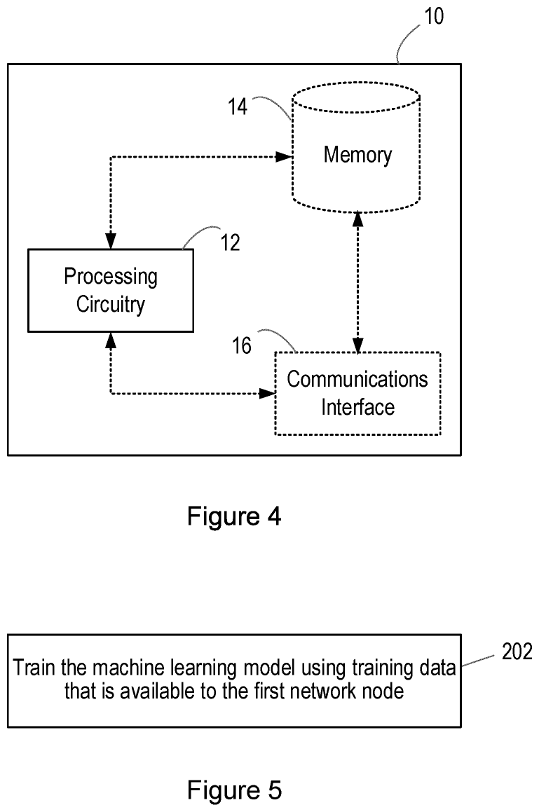

FIG. 3 is a flowchart illustrating a method performed by the coordinating entity 40 in accordance with an embodiment. The method is for handling training of a machine learning model. The coordinating entity 40 described earlier with reference to FIG. 2 is configured to operate in accordance with the method of FIG. 3. The method can be performed by or under the control of the processing circuitry 42 of the coordinating entity 40. The method is performed in response to receiving a request to train a machine learning model.

As illustrated at block 402 of FIG. 3, a first network node 10 is selected, from a plurality of network nodes 10, 20, 30, to train the machine learning model. More specifically, the processing circuitry 42 of the coordinating entity 40 selects the first network node 10. The first network node 10 is selected based on information indicative of a performance of each of the plurality of network nodes 10, 20, 30 and/or information indicative of a quality of a network connection to each of the plurality of network nodes. For example, the first network node 10 may be the network node with the best performance (e.g. indicated by a highest performance metric) and/or best quality of network connection (e.g. indicated by a highest quality metric). Alternatively, for example, the first network node 10 may be randomly selected from the network nodes with the best performance (e.g. indicated by a highest performance metric) and/or best quality of network connection (e.g. indicated by a highest quality metric).

Herein, the information indicative of the performance of each of the plurality of network nodes 10, 20, 30 can comprise information indicative of a past performance of each of the plurality of network nodes 10, 20, 30 and/or information indicative of an expected performance of each of the plurality of network nodes 10, 20, 30. In some embodiments, the information indicative of the past performance of each of the plurality of network nodes 10, 20, 30 may comprise a measure of a past effectiveness of each of the plurality of network nodes 10, 20, 30 in training machine learning models. This measure can be referred to as a reputation index. In embodiments where the information indicative of a performance comprises a reputation index for each of the plurality of network nodes 10, 20, 30, the first network node 10 may be selected as it has the highest reputation index. The reputation index can advantageously help to balance stability and plasticity.

Alternatively or in addition, in some embodiments, the information indicative of the expected performance of each of the plurality of network nodes 10, 20, 30 may comprise a measure of an available compute capacity of each of the plurality of network nodes 10, 20, 30. In some embodiments, the measure of an available compute capacity of each of the plurality of network nodes 10, 20, 30 can be represented as a measure of the load placed on each of the plurality of network nodes 10, 20, 30. For example, the higher the load placed on a network node, the lower the compute capacity of that network node. The measure of the load can be referred to as a load index. In a highly loaded network it may be difficult to find a network node to train the machine learning model. Taking into account the load index in the selection of a network node to train the machine learning model can prevent a highly loaded network node from becoming overloaded. In some embodiments involving both a reputation index and a load index, the first network node 10 may be selected based on the reputation index minus the load index for each of the plurality of network nodes 10, 20, 30.

Alternatively or in addition, in some embodiments, the information indicative of the expected performance of each of the plurality of network nodes 10, 20, 30 may comprise a measure of the quality and/or an amount of training data available to each of the plurality of network nodes 10, 20, 30. In some of these embodiments, the training data may be characterised using statistical metrics. For example, the following information can be used to characterise the training data in these embodiments (where the values next to the information are exemplary and, in the example, a two value input and two value output is assumed):
Number of available data from network node (input, output): 5432
Input
   Input 1 arithmetic mean: 54
   Input 1 standard deviation: 4.8
   Input 2 standard deviation: 557
   Input 2 standard deviation: 12.3
Output
   Output 1 arithmetic mean: 432
   Output 1 standard deviation: 12
   Output 2 standard deviation: 13576
   Output 2 standard deviation: 542

A similar characterisation may also exist for the reference data. Here, the arithmetic mean is the average value of all data, whereas the standard deviation provides information about the dispersion of the data around the mean. An exemplary, non-limiting selection algorithm may indicate that data with low standard deviation and/or approximate arithmetic means both for input and output are similar. Therefore, such a network node may not be selected to train the machine learning model, as the machine learning model has already been trained using similar training data.

Other statistical metrics that can be used besides, or in addition, to arithmetic mean and/or standard deviation are median, variance, proportion, mode, skewness, etc.

In some embodiments, the information indicative of the quality of the network connection to each of the plurality of network nodes 10, 20, 30 may comprise a measure of an available throughput of the network connection to each of the plurality of network nodes 10, 20, 30, a measure of a latency of the network connection to each of the plurality of network nodes 10, 20, 30, and/or a measure of a reliability of the network connection to each of the plurality of network nodes 10, 20, 30.

Thus, in the manner described, the first network node 10 can be selected, from a plurality of network nodes 10, 20, 30, to train the machine learning model. Returning back to FIG. 3, as illustrated at block 404, transmission of the machine learning model is initiated towards the first network node 10 for the first network node 10 to train the machine learning model. More specifically, the processing circuitry 42 of the coordinating entity 40 initiates transmission of the machine learning model towards the first network node 10. Herein, the term “initiate” can mean, for example, cause or establish. Thus, the processing circuitry 42 of the coordinating entity 40 can be configured to itself transmit the machine learning model (e.g. via a communications interface 46 of the coordinating entity 40) or can be configured to cause another node to transmit the machine learning model.

In some embodiments, the machine learning model can be a previously untrained machine learning model. In other embodiments, the machine learning model can be a machine learning model previously trained by another network node 20, 30 of the plurality of network nodes 10, 20, 30, e.g. by the second network node 20, the third network node 30, and/or any other network node.

Although not illustrated in FIG. 3, in some embodiments, in response to receiving the trained machine learning model from the first network node 10, the method may comprise checking whether the trained machine learning model meets a predefined threshold (which may, for example, be a value such as a percentage) for one or more performance metrics. More specifically, the processing circuitry 42 of the coordinating entity 40 can be configured to check this according to some embodiments. In some embodiments, checking whether the trained machine learning model meets a predefined threshold for one or more performance metrics may comprise comparing an output of the machine learning model resulting from the input of reference data into the machine learning model to an output of the trained machine learning model resulting from an input of the same reference data into the trained machine learning model, and analysing a difference in the outputs to check whether the trained machine learning model meets the predefined threshold for the one or more performance metrics. In this way, the reference data can be used to verify the training of the machine learning model. For example, if accuracy is the performance metric and 80% is the threshold, then the machine learning model is deemed acceptable (e.g. to the third party entity 50) if it has 80% or more accuracy when verified against the reference data.

In some embodiments involving a reputation index, the method may comprise updating the reputation index for the first network node 10 based on the difference in the outputs. More specifically, the processing circuitry 42 of the coordinating entity 40 can be configured to update the reputation index for the first network node 10 according to some embodiments. The reputation index for the first network node 10 is a measure of the effectiveness of the first network node 10 in training machine learning models compared to other network nodes 20, 30 of the plurality of network nodes 10, 20, 30. Each network node 10, 20, 30 may have an assigned reputation index.

The reputation index referred to herein can be a value, such as an integer value or a percentage value, according to some embodiments. In these embodiments, if the difference in the outputs mentioned earlier is indicative that the trained machine learning model meets the predefined threshold for the one or more performance metrics, the reputation index for the first network node 10 may be increased in value (e.g. by a value of 1, or by 1%). On the other hand, if the difference in the outputs mentioned earlier is indicative that the trained machine learning model does not meet the predefined threshold for the one or more performance metrics, the reputation index for the first network node 10 may be decreased in value (e.g. by a value of 1, or by 1%). In some embodiments, the amount by which the reputation index is updated may depend on the extent of the difference in the outputs mentioned earlier and thus, for example, the extent to which the trained machine learning model meets the predefined threshold for the one or more performance metrics. For example, if the performance metric is accuracy, and the difference in the outputs is indicative of a 5% reduction in accuracy, then the reputation index for the first network node 10 may be reduced by a value of 0.05. On the other hand, if the difference in the outputs is indicative of a 10% improvement in accuracy, then the reputation index for the first network node 10 may be increased by a value of 0.1.

In some embodiments, the method comprise determining whether to add training data, used by the first network node 10 to train the machine learning model, to the reference data based on the difference in the outputs. More specifically, the processing circuitry 42 of the coordinating entity 40 can be configured to determine this according to some embodiments. In some of these embodiments, the method comprise, in response to determining the training data is to be added to the reference data, initiating transmission of a request for the training data towards the first network node 10. More specifically, the processing circuitry 42 of the coordinating entity 40 can be configured to initiate transmission of (e.g. itself transmit, such as via a communications interface 46 of the coordinating entity 40, or cause another entity to transmit) a request for the training data according to some embodiments.

In some of these embodiments, the method may comprise, in response to receiving the training data, adding the training data to the reference data. More specifically, the processing circuitry 42 of the coordinating entity 40 can be configured to add the training data to the reference data according to some embodiments. If the machine learning model is a previously untrained machine learning model, an initial percentage of the training data (e.g. 5% of the total training data) may be added to the reference data.

In some embodiments, the amount of training data added to the reference data may depend on the verification described earlier. For example, if the machine learning model is a machine learning model previously trained by another network node and the verification shows that the machine learning model trained by the first network node 10 returns improved results (e.g. is more accurate) than before, as measured by the one or more performance metrics, a smaller percentage of the training data (e.g. 2% of the total training data) may be added to the reference data. Here, smaller percentage can mean a percentage that is smaller than the initial percentage mentioned earlier. On the other hand, for example, if the machine learning model is a machine learning model previously trained by another network node and the verification shows that the machine learning model trained by the first network node 10 returns worse results (e.g. is less accurate) than before, as measured by the one or more performance metrics, a larger percentage of the training data (e.g. 10% of the total training data) may be added to the reference data. Here, larger percentage can mean a percentage that is larger than the initial percentage mentioned earlier. In some embodiments, the verification described earlier may then be repeated, e.g. on the basis of the same one or more performance metrics and/or any other performance metric(s).

In embodiments involving a reputation index, if this subsequent verification shows that the machine learning model trained by the first network node 10 still returns worse results (e.g. is less accurate) than before, as measured by the one or more performance metrics, the reputation index for the first network node 10 may be updated with a negative value at this point. The amount by which the reputation index is changed can depend on the extent to which the results are worse according to some embodiments. For example, if the subsequent verification shows that the machine learning model trained by the first network node 10 is 5% less accurate than before, the reputation index for the first network node 10 may be updated with a value of −0.05.

On the other hand, if this subsequent verification shows that the machine learning model trained by the first network node 10 returns improved results (e.g. is more accurate) than before, as measured by the one or more performance metrics, the reputation index for the first network node 10 may be updated with a positive value at this point. As before, the amount by which the reputation index is changed can depend on the extent to which the results are worse according to some embodiments. For example, if the subsequent verification shows that the machine learning model trained by the first network node 10 is 5% more accurate than before, the reputation index for the first network node 10 may be updated with a value of 0.05. In other embodiments, the reputation index may be updated (e.g. in the manner described here) after the first verification.

If the (e.g. initial or a subsequent) verification shows that the machine learning model trained by the first network node 10 meets the predefined threshold for the one or more performance metrics, the training loop may be stopped and the trained machine learning model may be returned to the third party entity 50 that requested the training.

Although not illustrated in FIG. 3, in some embodiments, the method may comprise, in response to the first network node 10 completing the training of the machine learning model, or in response to a failure of the first network node 10 to train the machine learning model (e.g. due to there being insufficient compute resources available at the first network node 10 to train the machine learning model), selecting a second network node 20 from the plurality of network nodes 10, 20, 30. More specifically, the processing circuitry 42 of the coordinating entity 40 can be configured to select the second network node 20 according to some embodiments. The first network node 10 and the second network node 20 can be different network nodes. In some embodiments, selecting the second network node 20 may be in response to receiving the trained machine learning model from the first network node 10.

The second network node 20 may be selected to further train the trained machine learning model based on information indicative of a performance of each of the plurality of network nodes 10, 20, 30 and/or information indicative of a quality of a network connection to each of the plurality of network nodes 10, 20, 30. The information indicative of a performance of each of the plurality of network nodes 10, 20, 30 and/or information indicative of a quality of a network connection to each of the plurality of network nodes 10, 20, 30 can be that described earlier. Also, the second network node 20 may be selected in the same manner as the first network node 10, as described earlier. In some embodiments, the second network node 20 may be a neighbouring network node to the first network node 10.

In some embodiments involving a load index, the method may comprise updating the load index for the first network node 10 in response to a failure of the first network node 10 to train the machine learning model. More specifically, the processing circuitry 42 of the coordinating entity 40 can be configured to update the load index for the first network node 10 according to some embodiments. Herein, the load index for the first network node 10 is a measure of the load placed on the first network node 10 compared to other network nodes 20, 30 of the plurality of network nodes 10, 20, 30. Each network node 10, 20, 30 may have an assigned load index.

The load index referred to herein can be a value, such as an integer value or a percentage value, according to some embodiments. At the beginning of the method, the load index for all network nodes 10, 20, 30 may be initialised to zero. In some embodiments, if the first network node 10 fails to train the machine learning model due to the absence of computation capability, the load index for the first network node 10 may be increased (e.g. by a value of 1 or 1%). In some embodiments, the load index of all network nodes 10, 20, 30 may be reduced periodically (e.g. by 10%). In some embodiments, in order to stimulate diversity in the selection of network nodes, even if the first network node 10 trains the machine learning model, the load index of the first network node 10 may be increased (e.g. slightly, such as by a value of 0.5 or 0.5%). This can prevent a situation whereby the first network node 10, having been the most effective in training the machine learning model, continues to be selected due to a repeated increase in its reputation index.

In some embodiments where the second network node 20 is selected, the method may comprise initiating transmission of a request towards the second network node 20 to trigger a transfer (or handover) of the trained machine learning model from the first network node 10 to the second network node 20 for the second network node 20 to further train the machine learning model. More specifically, the processing circuitry 42 of the coordinating entity 40 can be configured to initiate transmission of (e.g. itself transmit, such as via a communications interface 46 of the coordinating entity 40, or cause another entity to transmit) this request according to some embodiments.

In some embodiments, the second network node 20 may be selected to further train the trained machine learning model and the transmission of the request towards the second network node 20 may be initiated to trigger the transfer, if the trained machine learning model fails to meet the one or more performance metrics. Alternatively, if the trained machine learning model meets the one or more performance metrics, the method may comprise initiating transmission of the trained machine learning model towards an entity (e.g. a third party entity) 50 that initiated transmission of the request to train the machine learning model. More specifically, the processing circuitry 42 of the coordinating entity 40 can be configured to initiate transmission of (e.g. itself transmit, such as via a communications interface 46 of the coordinating entity 40, or cause another entity to transmit) the trained machine learning model towards this entity 50 according to some embodiments.

In some embodiments, the method described earlier may be repeated in respect of at least one other different network node 30 of the plurality of network nodes 10, 20, 30 and/or in respect of one or more of the same network nodes 10, 20, e.g. when more training data becomes available to those one or more of the same network nodes 10, 20. Thus, the method can comprise a series of training rounds. In each training round, the machine learning model can be trained by a network node 10, 20, 30. In embodiments involving a reputation index, after each round of training by a network node 10, 20, 30, the reputation index for that network node may be updated, e.g. in the manner described earlier. Similarly, in embodiments involving a load index, after each round of training by a network node 10, 20, 30, the load index for that network node may be updated, e.g. in the manner described earlier.

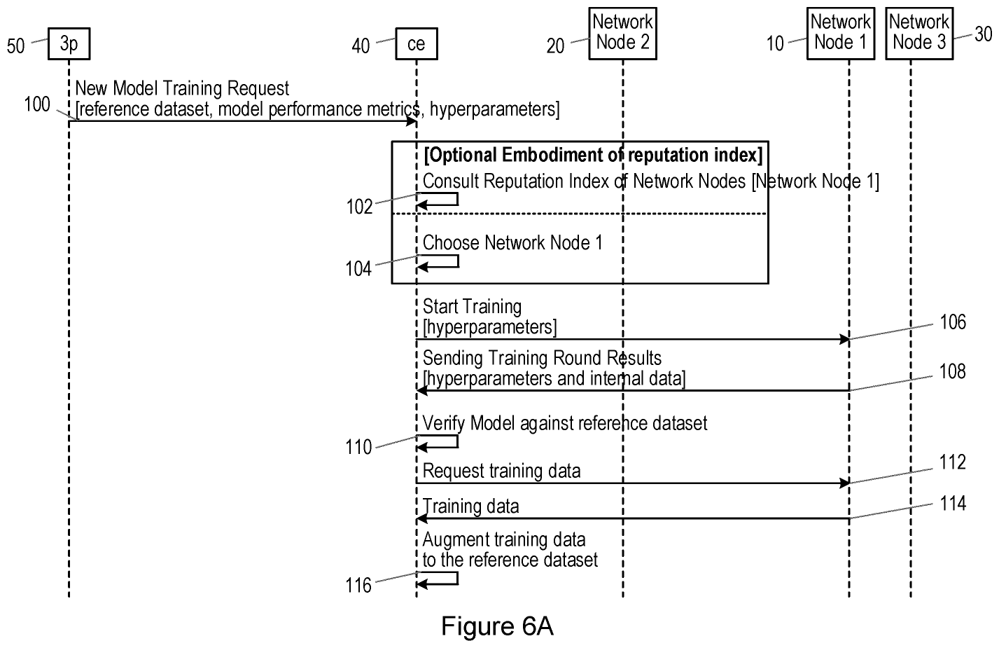

FIG. 4 illustrates the first network node 10 in accordance with an embodiment. The first network node 10 is for assessing network performance. The first network node 10 may, for example, be a physical machine (e.g. a server) or a virtual machine (VM). In some embodiments, the network node can be a base station, a baseband node, a cell, or any other network node. In embodiments where the network is a RAN, the network node can be a RAN node or a radio base station.

As illustrated in FIG. 4, the first network node 10 comprises processing circuitry (or logic) 12. The processing circuitry 12 controls the operation of the first network node 10 and can implement the method described herein in respect of the first network node 10. The processing circuitry 12 can be configured or programmed to control the first network node 10 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first network node 10. In some embodiments, the processing circuitry 12 can be configured to run software to perform the method described herein in respect of the first network node 10. The software may be containerised according to some embodiments. In some embodiments, the software may be a software update for the first network node 10. Thus, in some embodiments, the processing circuitry 12 may be configured to run a container to perform the method described herein in respect of the first network node 10.

Briefly, the processing circuitry 12 of the first network node 10 is configured to, in response to receiving the machine learning model from the coordinating entity 40, train the machine learning model using training data that is available to the first network node.

As illustrated in FIG. 4, in some embodiments, the first network node 10 may optionally comprise a memory 14. The memory 14 of the first network node 10 can comprise a volatile memory or a non-volatile memory. In some embodiments, the memory 14 of the first network node 10 may comprise a non-transitory media. Examples of the memory 14 of the first network node 10 include, but are not limited to, a random access memory (RAM), a read only memory (ROM), a mass storage media such as a hard disk, a removable storage media such as a compact disk (CD) or a digital video disk (DVD), and/or any other memory.

The processing circuitry 12 of the first network node 10 can be connected to the memory 14 of the first network node 10. In some embodiments, the memory 14 of the first network node 10 may be for storing program code or instructions which, when executed by the processing circuitry 12 of the first network node 10, cause the first network node 10 to operate in the manner described herein in respect of the first network node 10. For example, in some embodiments, the memory 14 of the first network node 10 may be configured to store program code or instructions that can be executed by the processing circuitry 12 of the first network node 10 to cause the first network node 10 to operate in accordance with the method described herein in respect of the first network node 10. Alternatively or in addition, the memory 14 of the first network node 10 can be configured to store any information, data, messages, requests, responses, indications, notifications, signals, or similar, that are described herein. The processing circuitry 12 of the first network node 10 may be configured to control the memory 14 of the first network node to store information, data, messages, requests, responses, indications, notifications, signals, or similar, that are described herein.

In some embodiments, as illustrated in FIG. 4, the first network node 10 may optionally comprise a communications interface 16. The communications interface 16 of the first network node 10 can be connected to the processing circuitry 12 of the first network node 10 and/or the memory 14 of first network node 10. The communications interface 16 of the first network node 10 may be operable to allow the processing circuitry 12 of the first network node 10 to communicate with the memory 14 of the first network node 10 and/or vice versa. Similarly, the communications interface 16 of the first network node 10 may be operable to allow the processing circuitry 12 of the first network node 10 to communicate with coordinating entity 40, at least one other network node 20, 30, or any other node described herein. The communications interface 16 of the first network node 10 can be configured to transmit and/or receive information, data, messages, requests, responses, indications, notifications, signals, or similar, that are described herein. In some embodiments, the processing circuitry 12 of the first network node 10 may be configured to control the communications interface 16 of the first network node 10 to transmit and/or receive information, data, messages, requests, responses, indications, notifications, signals, or similar, that are described herein.

Although the first network node 10 is illustrated in FIG. 4 as comprising a single memory 14, it will be appreciated that the first network node 10 may comprise at least one memory (i.e. a single memory or a plurality of memories) 14 that operate in the manner described herein. Similarly, although the first network node 10 is illustrated in FIG. 4 as comprising a single communications interface 16, it will be appreciated that the first network node 10 may comprise at least one communications interface (i.e. a single communications interface or a plurality of communications interface) 16 that operate in the manner described herein. It will also be appreciated that FIG. 4 only shows the components required to illustrate an embodiment of the first network node 10 and, in practical implementations, the first network node 10 may comprise additional or alternative components to those shown.

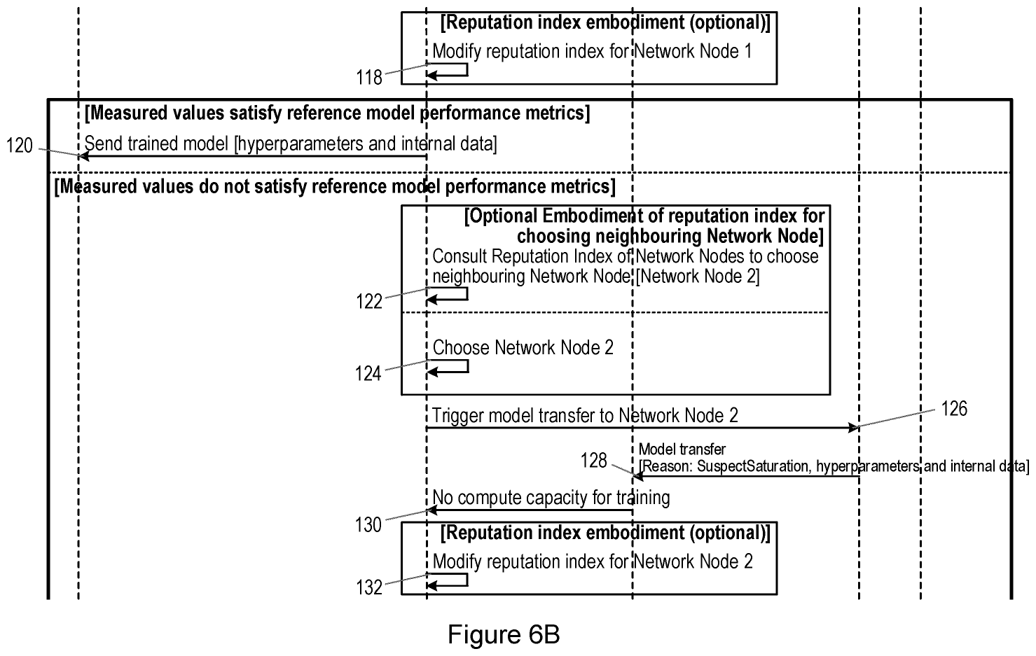

FIG. 5 is a flowchart illustrating a method performed by the first network node 10 in accordance with an embodiment. The method is for handling training of machine learning model. The first network node 10 described earlier with reference to FIG. 4 is configured to operate in accordance with the method of FIG. 5. The method can be performed by or under the control of the processing circuitry 12 of the first network node 10.

As illustrated at block 202 of FIG. 5, in response to receiving the machine learning model from the coordinating entity 40, the machine learning model is trained using training data that is available to the first network node 10, such as data that is local to the first network node 10. More specifically, the processing circuitry 12 of the first network node 10 trains the machine learning model. Thus, it can be assumed that the first network node 10 can supply its own training data for the machine learning model. In some embodiments, the training data that is available to the first network node 10 can comprise data from one or more devices (e.g. user equipments, UEs) registered to the first network node 10. In some embodiments, the training data can comprise data from one or more counters (e.g. eNB/gNB counters) and/or baseband control information. The data from one or more counters may comprise one or more parameters that characterise the one or more devices (e.g. UEs) attached to the first network node 10, while the baseband control information may comprise a configuration of the first network node 10. The training data may comprise subsets of any of these features and this can depend on the machine learning model.

In some embodiments, prior to training the machine learning model, the training data may be compared to reference data for similarity and training data that is similar to the reference data (e.g. similar input and output values in the data) may be filtered out. More specifically, the processing circuitry 12 of the first network node 10 may compare the training data to reference data and filter out similar data. One way of comparing data for similarity is using a cosine similarity calculation, which considers that both input and output values can be represented as vectors. A cosine similarity indicates the cosine of the angle of vectors. In embodiments using this form of similarity comparison, the input and output vectors of training data can be compared to the input and output vectors of the reference data. If, in any of these comparisons, the cosine of the angle between the two compared input and two compared output vectors is greater than or equal to a threshold (e.g. 0.9), then the training data to which the compared input and output vectors relate may be discarded. By filtering out training data in this way, the machine learning model can be trained using more up to date training data (to avoid plasticity), while preserving training data previously learnt (to ensure stability).

In some embodiments, the method performed by the first network node 10 may comprise continuing to train the machine learning model using the training data that is available to the first network node 10 until a maximum accuracy for the trained machine learning model is reached (e.g. until the first network node 10 can no longer improve the accuracy of the machine learning model) and/or until the first network node 10 runs out of computational capacity to train the machine learning model (e.g. until the computational capacity for the first network node 10 is not enough to train the machine learning model). More specifically, the processing circuitry 12 of the first network node 10 may continue to train the machine learning model in this way according to some embodiments. In some embodiments, the point at which the maximum accuracy for the trained machine learning model is reached may be the point at which no improvement against the one or more performance metrics is noticeable. The first network node 10 may train the machine learning model incrementally.

In some embodiments, the method performed by the first network node 10 may comprise, in response to receiving a request for the training data, where transmission of the request is initiated by the coordinating entity 40, initiating transmission of the training data towards the coordinating entity 40. More specifically, the processing circuitry 12 of the first network node 10 may initiate transmission of (e.g. itself transmit, such as via a communications interface 16 of the first network node 10, or cause another node to transmit) the training data towards the coordinating entity 40 according to some embodiments.

In some embodiments, the method performed by the first network node 10 may comprise initiating transmission of the trained machine learning model towards the coordinating entity 40. More specifically, the processing circuitry 12 of the first network node 10 may initiate transmission of (e.g. itself transmit, such as via a communications interface 16 of the first network node 10, or cause another node to transmit) the trained machine learning model towards the coordinating entity 40 according to some embodiments.

In some embodiments, the method performed by the first network node 10 may comprise, in response to receiving a request to trigger a transfer (or handover) of the trained machine learning model from the first network node 10 to the second network node 20, initiating the transfer (or handover) of the trained machine learning model from the first network node 10 to the second network node 20 for the second network node 20 to further train the machine learning model. More specifically, the processing circuitry 12 of the first network node 10 may initiate the transfer of the trained machine learning model according to some embodiments. Thus, in a mobile network implementation, the first network node 10 may not only performs handover of user equipments (UEs) but also machine learning models. In some embodiments, the transfer may comprise transferring one or more model parameters (e.g. hyperparameters) of the machine learning model and optionally also the internal data of the machine learning model (and/or, if appropriate, the weights of the machine learning model). The first network node 10 may itself transfer (e.g. transmit, such as via a communications interface 16 of the first network node 10) the machine learning model to the second network node 20, or cause another node to transfer (e.g. transmit) the machine learning model to the second network node 20.

The second network node 20 may further train the trained machine learning model in the same way as the first network node 10 trains the machine learning model and thus the description of the method performed by the first network node 10 will be understood to also apply to the second network node 20, and any other network node that is used to train or further train the (trained) machine learning model.

There is also provided a system (such as that illustrated in FIG. 1), which comprises a coordinating entity 40 as described earlier with reference to FIGS. 2 and 3, and a plurality of network nodes 10, 20, 30. The plurality of network nodes can comprise at least one first network node 10 as described earlier with reference to FIGS. 4 and 5.

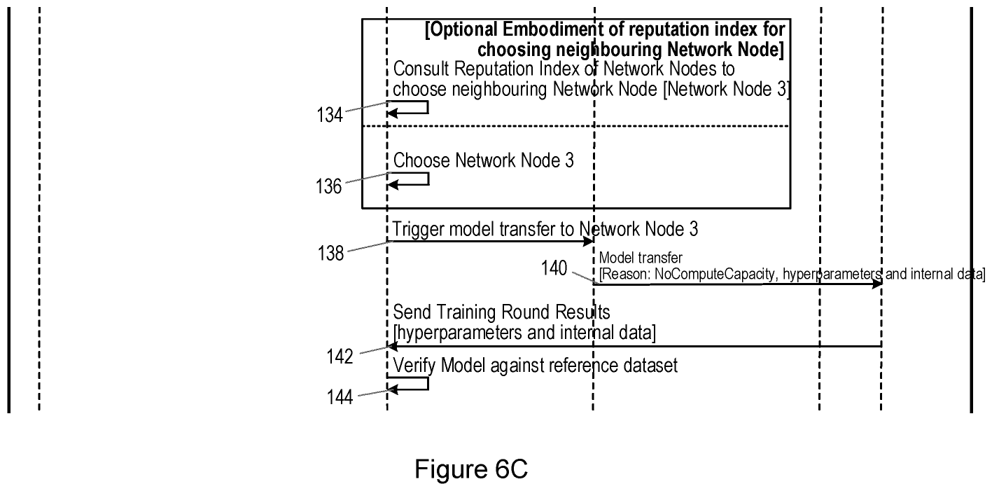

FIG. 6A-D is a signalling diagram illustrating an exchange of signals in such a system according to an embodiment. The system illustrated in FIG. 6A-D comprises a coordinating entity 40. The coordinating entity 40 can be as described earlier with reference to FIGS. 2 and 3. The system illustrated in FIG. 6A-D comprises a plurality of network nodes 10, 20, 30, namely a first network node 10, a second network node 20, and a third network node 30. However, it will be understood that the system may comprise any other number of network nodes. The first network node 10 and optionally also any one or more of the second and third network nodes 20, 30 can be as described earlier with reference to FIGS. 4 and 5. The system illustrated in FIG. 6A-D comprises a third party entity 50.

As illustrated by arrow 100 of FIG. 6A-D, the third party entity 50 initiates transmission of a request towards the coordinating entity 40. The request is for a machine learning model to be trained. In some embodiments, the request can comprise reference data (or a reference dataset), one or more performance metrics, and/or one or more model parameters (e.g. hyperparameters). As illustrated by arrow 102 of FIG. 6A-D, the coordinating entity 40 may check information indicative of a performance of each of the plurality of network nodes 10, 20, 30 and/or information indicative of a quality of a network connection to each of the plurality of network nodes. This information can comprise the reputation index of each of the plurality of network nodes 10, 20, 30 and/or any other of the types of information described earlier.

As illustrated by arrow 104 of FIG. 6A-D, the coordinating entity 40 selects a first network node 10 from the plurality of network nodes 10, 20, 30. The first network node 10 is selected to train the machine learning model. The first network node 10 is selected based on the information indicative of the performance of each of the plurality of network nodes 10, 20, 30 and/or the information indicative of the quality of the network connection to each of the plurality of network nodes 10, 20, 30, e.g. as described earlier.

As illustrated by arrow 106 of FIG. 6A-D, the coordinating entity 40 initiates transmission of the machine learning model towards the first network node 10 for the first network node 10 to train the machine learning model. For example, the coordinating entity 40 may initiate transmission of one or more model parameters (e.g. hyperparameters) of the machine learning model towards the first network node 10. In response to receiving the machine learning model from the coordinating entity 40, the first network node 10 trains the machine learning model using training data that is available to the first network node 10. As illustrated by arrow 108 of FIG. 6A-D, the first network node 10 initiates transmission of the trained machine learning model towards the coordinating entity 40. For example, the first network node 10 may initiate transmission of one or more model parameters (e.g. hyperparameters) of the trained machine learning model towards the coordinating entity 40 and optionally also the internal data of the trained machine learning model (and/or, if appropriate, the weights of the trained machine learning model).

As illustrated by arrow 110 of FIG. 6A-D, in response to receiving the trained machine learning model from the first network node 10, the coordinating entity 40 checks whether the trained machine learning model meets a predefined threshold for one or more performance metrics. For example, the coordinating entity 40 may compare an output of the machine learning model resulting from the input of reference data into the machine learning model to an output of the trained machine learning model resulting from an input of the same reference data into the trained machine learning model, and analyse a difference in the outputs to check whether the trained machine learning model meets the predefined threshold for the one or more performance metrics.

As illustrated by arrow 112 of FIG. 6A-D, the coordinating entity 40 initiates transmission of a request for the training data towards the first network node 10. As illustrated by arrow 114 of FIG. 6A-D, in response to receiving the request for the training data, the first network node 10 initiates transmission of the training data towards the coordinating entity 40. As illustrated by arrow 116 of FIG. 6A-D, in response to receiving the training data, the coordinating entity 40 adds the training data to the reference data. As illustrated by arrow 118 of FIG. 6A-D, in some embodiments involving a reputation index, the coordinating entity 40 may update the reputation index for the first network node 10 based on the difference in the outputs described earlier with reference to arrow 110 of FIG. 6A-D.

As illustrated by arrow 120 of FIG. 6A-D, if the trained machine learning model meets the one or more performance metrics described earlier with reference to arrow 110 of FIG. 6A-D, the coordinating entity 40 initiates transmission of the trained machine learning model towards the third party entity 50 that initiated transmission of the request 100 to train the machine learning model. For example, the coordinating entity 40 may initiate transmission of one or more model parameters (e.g. hyperparameters) of the trained machine learning model towards the third party entity 50 and optionally also the internal data of the trained machine learning model (and/or, if appropriate, the weights of the trained machine learning model). On the other hand, as illustrated by arrow 122 of FIG. 6A-D, if the trained machine learning model fails to meet the one or more performance metrics, the coordinating entity 40 may check the information indicative of the performance of each of the plurality of network nodes 10, 20, 30 and/or the information indicative of the quality of the network connection to each of the plurality of network nodes. This information can comprise the reputation index of each of the plurality of network nodes 10, 20, 30 and/or any other of the types of information described earlier.

As illustrated by arrow 124 of FIG. 6A-D, the coordinating entity 40 selects the second network node 20 from the plurality of network nodes 10, 20, 30. The second network node 20 is selected to further train the trained machine learning model. Thus, in response to the first network node 10 completing the training of the machine learning model, the second network node 20 is selected from the plurality of network nodes 10, 20, 30. The second network node 20 is selected based on the information indicative of the performance of each of the plurality of network nodes 10, 20, 30 and/or the information indicative of the quality of the network connection to each of the plurality of network nodes 10, 20, 30, e.g. as described earlier.

As illustrated by arrow 126 of FIG. 6A-D, the coordinating entity 40 initiates transmission of a request towards the second network node 20 to trigger a transfer (or handover) of the trained machine learning model from the first network node 10 to the second network node 20 for the second network node 20 to further train the machine learning model. As illustrated by arrow 128 of FIG. 6A-D, in response to receiving the request to trigger the transfer of the trained machine learning model from the first network node 10 to the second network node 20, the first network node 10 initiates the transfer of the trained machine learning model from the first network node 10 to the second network node 20 for the second network node 20 to further train the machine learning model. For example, the first network node 10 may initiate transfer of one or more model parameters (e.g. hyperparameters) of the trained machine learning model and optionally also the internal data of the trained machine learning model (and/or, if appropriate, the weights of the trained machine learning model).

As illustrated by arrow 130 of FIG. 6A-D, the second network node 20 initiates transmission of a message (or notification) towards the coordinating entity 40. The message can be indicative that the second network node 20 has failed to train the machine learning model (e.g. due to not having enough compute capacity for the training). In some embodiments, the message may be indicative of the reason for the failure, e.g. “NoComputeResource”. As illustrated by arrow 132 of FIG. 6A-D, in some embodiments involving a reputation index, the coordinating entity 40 may update the reputation index for the second network node 20 based on the failure.

As illustrated by arrow 134 of FIG. 6A-D, the coordinating entity 40 may check the information indicative of the performance of each of the plurality of network nodes 10, 20, 30 and/or the information indicative of the quality of the network connection to each of the plurality of network nodes. This information can comprise the reputation index of each of the plurality of network nodes 10, 20, 30 and/or any other of the types of information described earlier. As illustrated by arrow 136 of FIG. 6A-D, the coordinating entity 40 selects the third network node 30 from the plurality of network nodes 10, 20, 30. Thus, in response to the failure of the second network node 20 to train the machine learning model, the third network node 30 is selected from the plurality of network nodes 10, 20, 30. The third network node 30 is selected to further train the trained machine learning model.

The third network node 30 is selected based on the information indicative of the performance of each of the plurality of network nodes 10, 20, 30 and/or the information indicative of the quality of the network connection to each of the plurality of network nodes 10, 20, 30, e.g. as described earlier. For example, the third network node 30 may be the network node with the best performance (e.g. indicated by a highest performance metric) and/or best quality of network connection (e.g. indicated by a highest quality metric). Alternatively, for example, the third network node 30 may be a network node randomly selected from the network nodes with the best performance (e.g. indicated by a highest performance metric) and/or best quality of network connection (e.g. indicated by a highest quality metric).

As illustrated by arrow 138 of FIG. 6A-D, the coordinating entity 40 initiates transmission of a request towards the second network node 20 to trigger a transfer (or handover) of the trained machine learning model from the second network node 20 to the third network node 30 for the third network node 30 to further train the machine learning model. As illustrated by arrow 140 of FIG. 6A-D, in response to receiving the request to trigger the transfer of the trained machine learning model from the second network node 20 to the third network node 30, the second network node 20 initiates the transfer of the trained machine learning model from the second network node 20 to the third network node 30 for the third network node 30 to further train the machine learning model. For example, the second network node 20 may initiate transfer of one or more model parameters (e.g. hyperparameters) of the trained machine learning model and optionally also the internal data of the trained machine learning model (and/or, if appropriate, the weights of the trained machine learning model). Thus, in every training round, the previous network node can initiate transfer of the machine learning model to the next network node. In response to receiving the trained machine learning model from the second network node 20, the third network node 30 further trains the trained machine learning model using training data that is available to the third network node 30.

As illustrated by arrow 142 of FIG. 6A-D, the third network node 30 initiates transmission of the further trained machine learning model towards the coordinating entity 40. For example, the third network node 30 may initiate transmission of one or more model parameters (e.g. hyperparameters) of the further trained machine learning model towards the coordinating entity 40 and optionally also the internal data of the further trained machine learning model (and/or, if appropriate, the weights of the further trained machine learning model).

As illustrated by arrow 144 of FIG. 6A-D, in response to receiving the further trained machine learning model from the third network node 30, the coordinating entity 40 checks whether the further trained machine learning model meets the predefined threshold for one or more performance metrics. For example, the coordinating entity 40 may compare an output of the machine learning model resulting from the input of reference data into the machine learning model (or an output of the trained machine learning model resulting from the input of reference data into the trained machine learning model) to an output of the further trained machine learning model resulting from an input of the same reference data into the further trained machine learning model, and analyse a difference in the outputs to check whether the further trained machine learning model meets the predefined threshold for the one or more performance metrics.

As illustrated by arrow 148 of FIG. 6A-D, in some embodiments involving a reputation index, the coordinating entity 40 may update the reputation index for the third network node 30 based on the difference in the outputs described earlier with reference to arrow 144 of FIG. 6A-D.

As illustrated by arrow 150 of FIG. 6A-D, if the further trained machine learning model meets the one or more performance metrics described earlier with reference to arrow 110 of FIG. 6A-D, the coordinating entity 40 initiates transmission of the further trained machine learning model towards the third party entity 50 that initiated transmission of the request 100 to train the machine learning model. For example, the coordinating entity 40 may initiate transmission of one or more model parameters (e.g. hyperparameters) of the further trained machine learning model towards the third party entity 50 and optionally also the internal data of the further trained machine learning model (and/or, if appropriate, the weights of the further trained machine learning model). On the other hand, as illustrated by arrow 152 of FIG. 6A-D, the coordinating entity 40 initiates transmission of a request for the training data towards the third network node 30. As illustrated by arrow 154 of FIG. 6A-D, in response to receiving the request for the training data, the third network node 30 initiates transmission of the training data towards the coordinating entity 40. As illustrated by arrow 156 of FIG. 6A-D, in response to receiving the training data, the coordinating entity 40 adds the training data to the reference data.

As illustrated by arrow 158 of FIG. 6A-D, the method described above may be repeated in respect of at least one other different network node of the plurality of network nodes (not illustrated) and/or in respect of one or more of the same network nodes 10, 20, 30, e.g. when more training data becomes available to those one or more of the same network nodes 10, 20, 30.

Although some examples are provided earlier for the training data, it will be understood that the training date used will depend on the use case for which machine learning model is trained. The table below illustrates some example use cases and the type of training date that may be used, where the training data comprises data from one or more counters (e.g. eNB/gNB counters) and/or baseband control information.

| | | | Baseband |
|---|---|---|---|
| Use Case | | | control |
| Description | eNB/gNB counter(s) and value range | | information |
| Use Case 1: State of | pmBatteryTemperatureDistr | Battery temperature is | Alarm |
| Battery Supply | | continuously measured, | the following |
| System. In this use | | and minutes of battery | information- |
| case, battery | | temperature are recorded | alarms may |
| temperature and | | in this counter. The | indicate an |
| battery discharge | | counter has 17 different | unstable |
| duration is | | classes, each class | battery |
| measured to identify | | accounting for 4 degrees | system: |
| potential issues with | | Celsius between “less | Battery |
| the battery-based | | than −5” and to “greater | Capacity |
| power supply (e.g. | | than 70” degrees Celsius. | Degraded, |
| batteries | | For example, the first | Battery End of |
| overheating and/or | | class is less than 5 | Life, |
| discharging fast). | | degrees Celsius, the | Battery High |
| The model takes into | | second class is between | Temperature, |
| account various | | −5 and −1, the third class | Loss of Mains, |
| counters to indicate | | between 0 and 4, the | Low Battery |
| a stable or unstable | | fourth class between 5 | Capacity. |
| battery supply | | and 9, etc. | |
| system. The training | pmBatteryDept | Distribution of battery | |
| data is constructed | hOfDischarge | Depth of Discharge (DoD). | |
| as follows: If the | Distr | Initial counter value is | |
| values of the | | internal measurement | |
| counters generate | | result since battery | |
| the power-related | | installation. The counter | |
| alarms, this means | | has 7 different classes | |
| that the battery | | indicating number of times | |
| system is unstable. | | battery voltage was in a | |
| On the other hand, if | | specific range (from less | |
| the values of the | | than 40.8 V to greater than | |
| counters do not | | 46.8 V). | |
| generate an alarm, | pmBatteryDischargeTimeDistr | Distribution of battery | |
| this means that the | | discharge durations. Initial | |
| battery system is | | counter value is internal | |
| stable. | | measurement result since | |
| | | battery installation. The | |
| | | counter has 8 different | |
| | | classes indicating the | |
| | | number of battery | |
| | | discharges that last from | |
| | | less than 3 minutes to | |
| | | more than 479 minutes. | |
| | pmBatteryCapacityTotalDelivered | Total capacity of battery | |
| | | delivered in Amps | |
| Use Case 2: Faulty | ifHCLossOfSignal | Total number of times | Alarm |
| backhaul | | connection is lost due to | information- |
| connection. In this | | all links in a link | the following |
| use case, we use | | aggregation group (LAG) | alarms may |
| network | | having Ethernet link | indicate an |
| performance | | failures, measure via loss | unstable |
| management (PM) | | of signal detection. | transport |
| counters to identify | ifInErrors | The number of inbound | network (i.e. |
| whether the | | packets that contained | backhaul |
| backhaul connection | | errors preventing them | connection): |
| from the eNB/gNB to | | from being deliverable to a | Ethernet Link |
| the core network of | | higher-layer protocol. | Failure, |
| the operator is | ifMaxLossOfSignalDuration/ | Maximum/Minimum | Dynamic Host |
| faulty. As is the case | ifMinLossOfSignalDuration | duration in milliseconds | Configuration |
| with the previous | | where connection is lost | Protocol |
| example, a number | | due to all links in the LAG | (DHCP) Lease |
| of PM counter | | having Ethernet link | Expiry, |
| values are combined | | failures, measured via loss | Clock |
| with alarms to | | of signal detection. | Reference |
| classify whether a | ifTotalLossOfSignalDuration | Total duration in | Missing For |
| backhaul connection | | milliseconds where LAG is | Long Time, |
| has issues or not. | | operationally disabled due | Tagged Image |
| | | to Ethernet link failures for | File Format |
| | | all encapsulated Ethernet | (TIF) Server |
| | | ports, measured via loss | Not Reachable |
| | | of signal detection. | |

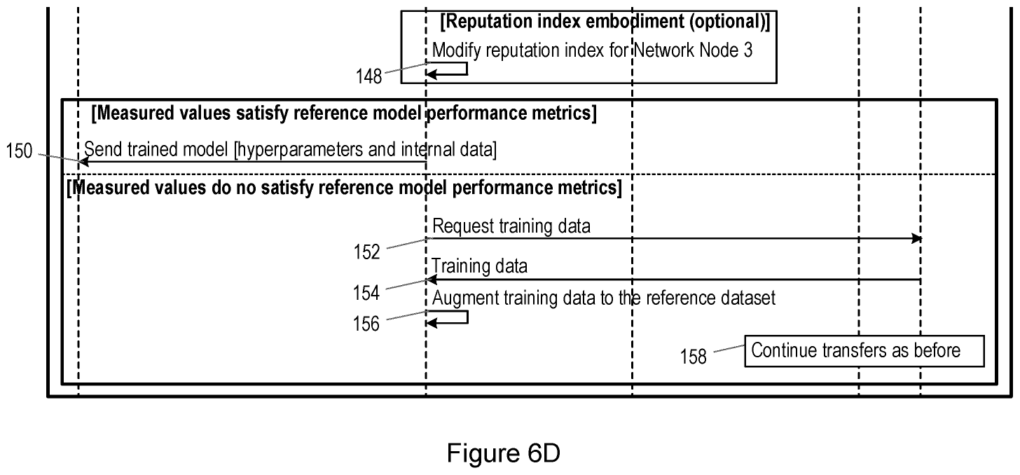

FIG. 7 is a block diagram illustrating a coordinating entity 500 in accordance with an embodiment. The coordinating entity 500 comprises a selecting module 502 configured to, in response to receiving a request to train the machine learning model, select, from a plurality of network nodes, a first network node to train the machine learning model based on information indicative of a performance of each of the plurality of network nodes and/or information indicative of a quality of a network connection to each of the plurality of network nodes. The coordinating entity 500 comprises a transmission initiating module 504 configured to initiate transmission of the machine learning model towards the first network node for the first network node to train the machine learning model. The coordinating entity 500 may operate in the manner described herein in respect of the coordinating entity.

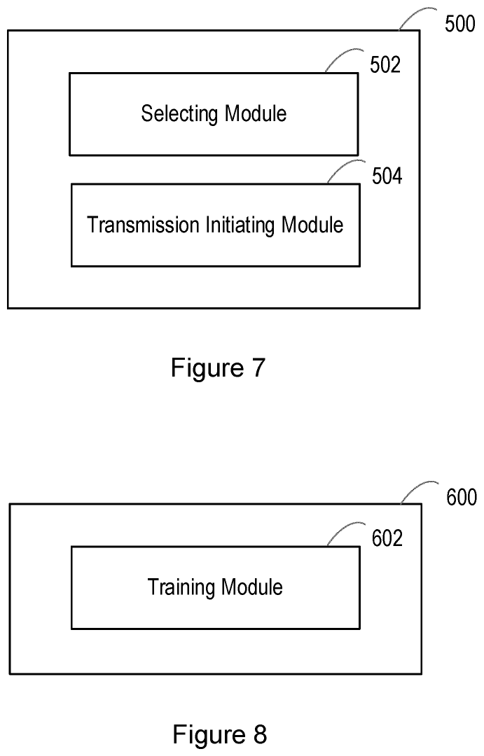

FIG. 8 is a block diagram illustrating a first network node 600 in accordance with an embodiment. The first network node 600 comprises a training module 602 configured to, in response to receiving the machine learning model from the coordinating entity 500, train the machine learning model using training data that is available to the first network node 600. The first network node 600 may operate in the manner described herein in respect of the first network node.

There is also provided a computer program comprising instructions which, when executed by processing circuitry (such as the processing circuitry 12 of the first network node 10 described earlier and/or the processing circuitry 42 of the coordinating entity 40 described earlier), cause the processing circuitry to perform at least part of the method described herein. There is provided a computer program product, embodied on a non-transitory machine-readable medium, comprising instructions which are executable by processing circuitry (such as the processing circuitry 12 of the first network node 10 described earlier and/or the processing circuitry 42 of the coordinating entity 40 described earlier) to cause the processing circuitry to perform at least part of the method described herein. There is provided a computer program product comprising a carrier containing instructions for causing processing circuitry (such as the processing circuitry 12 of the first network node 10 described earlier and/or the processing circuitry 42 of the coordinating entity 40 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the first network node functionality, the coordinating entity functionality, and/or any other node/entity functionality described herein can be performed by hardware. Thus, in some embodiments, the first network node 10, the coordinating entity 40, and/or any other node/entity described herein can be a hardware node/entity. However, it will also be understood that optionally at least part or all of the first network node functionality, the coordinating entity functionality, and/or any other node/entity functionality described herein can be virtualized. For example, the functions performed by the first network node 10, the coordinating entity 40, and/or any other node/entity described herein can be implemented in software running on generic hardware that is configured to orchestrate the node/entity functionality. Thus, in some embodiments, the first network node 10, the coordinating entity 40, and/or any other node/entity described herein can be a virtual node/entity. In some embodiments, at least part or all of the first network node functionality, the coordinating entity functionality, and/or any other node/entity functionality described herein may be performed in a network enabled cloud. The first network node functionality, the coordinating entity functionality, and/or any other node/entity functionality described herein may all be at the same location or at least some of the node/entity functionality may be distributed.

It will be understood that at least some or all of the method steps described herein can be automated in some embodiments. That is, in some embodiments, at least some or all of the method steps described herein can be performed automatically.

Thus, in the manner described herein, there is advantageously provided techniques for handling training of machine learning model.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for handling training of a machine learning model, wherein the method is performed by a coordinating entity that is operable to coordinate the training of the machine learning model at one or more network nodes and the method comprises:
in response to receiving a request to train the machine learning model:
selecting, from a plurality of network nodes, a first network node to train the machine learning model based on information indicative of a performance of each of the plurality of network nodes and/or information indicative of a quality of a network connection to each of the plurality of network nodes; and
initiating transmission of the machine learning model towards the first network node for the first network node to train the machine learning model.

2. A method as claimed in claim 1, wherein:
the machine learning model is:
a previously untrained machine learning model; or
a machine learning model previously trained by another network node of the plurality of network nodes.

3. A method as claimed in claim 1, the method comprising:
in response to receiving the trained machine learning model from the first network node:
checking whether the trained machine learning model meets a predefined threshold for one or more performance metrics.

4. A method as claimed in claim 3, wherein:
checking whether the trained machine learning model meets a predefined threshold for one or more performance metrics comprises:
comparing an output of the machine learning model resulting from the input of reference data into the machine learning model to an output of the trained machine learning model resulting from an input of the same reference data into the trained machine learning model; and
analyzing a difference in the outputs to check whether the trained machine learning model meets the predefined threshold for the one or more performance metrics.

5. A method as claimed in claim 4, the method comprising:
updating a reputation index for the first network node based on the difference in the outputs, wherein the reputation index for the first network node is a measure of the effectiveness of the first network node in training machine learning models compared to other network nodes of the plurality of network nodes.

6. A method as claimed in claim 4, the method comprising:
determining whether to add training data, used by the first network node to train the machine learning model, to the reference data based on the difference in the outputs.

7. A method as claimed in claim 6, the method comprising:
in response to determining the training data is to be added to the reference data:
initiating transmission of a request for the training data towards the first network node; and
in response to receiving the training data:
adding the training data to the reference data.

8. A method as claimed in claim 1, the method comprising:
in response to the first network node completing the training of the machine learning model, or in response to a failure of the first network node (10) to train the machine learning model:
selecting, from the plurality of network nodes, a second network node to further train the trained machine learning model based on information indicative of a performance of each of the plurality of network nodes and/or information indicative of a quality of a network connection to each of the plurality of network nodes, wherein the first network node and the second network node are different network nodes; and
initiating transmission of a request towards the second network node to trigger a transfer of the trained machine learning model from the first network node to the second network node for the second network node to further train the machine learning model.

9. A method as claimed in claim 3, the method comprising:
in response to the first network node completing the training of the machine learning model, or in response to a failure of the first network node (10) to train the machine learning model:
selecting, from the plurality of network nodes, a second network node to further train the trained machine learning model based on information indicative of a performance of each of the plurality of network nodes and/or information indicative of a quality of a network connection to each of the plurality of network nodes, wherein the first network node and the second network node are different network nodes;
initiating transmission of a request towards the second network node to trigger a transfer of the trained machine learning model from the first network node to the second network node for the second network node to further train the machine learning model; and
if the trained machine learning model fails to meet the one or more performance metrics, selecting the second network node to further train the trained machine learning model and initiating the transmission of the request towards the second network node to trigger the transfer; or
if the trained machine learning model meets the one or more performance metrics, initiating transmission of the trained machine learning model towards an entity that initiated transmission of the request to train the machine learning model.

10. A method as claimed in claim 8, wherein:
selecting the second network node is in response to receiving the trained machine learning model from the first network node.

11. A method as claimed in claim 8, wherein:
the method is repeated in respect of at least one other different network node (30) of the plurality of network nodes.

12. A method as claimed in claim 1, wherein:
the information indicative of the performance of each of the plurality of network nodes comprises:
information indicative of a past performance of each of the plurality of network nodes; and/or
information indicative of an expected performance of each of the plurality of network nodes.

13. A method as claimed in claim 12, wherein:
the information indicative of the past performance of each of the plurality of network nodes comprises:
a measure of a past effectiveness of each of the plurality of network nodes in training machine learning models; and/or
the information indicative of the expected performance of each of the plurality of network nodes comprises:
a measure of an available compute capacity of each of the plurality of network nodes; and/or
a measure of the quality and/or an amount of training data available to each of the plurality of network nodes.

14. A method as claimed in claim 1, wherein:
the information indicative of the quality of the network connection to each of the plurality of network nodes comprises:
a measure of an available throughput of the network connection to each of the plurality of network nodes;
a measure of a latency of the network connection to each of the plurality of network nodes; and/or
a measure of a reliability of the network connection to each of the plurality of network nodes.

15. A coordinating entity comprising:
processing circuitry configured to operate in accordance with claim 1.

16. A coordinating entity comprising:
processing circuitry; and
at least one memory for storing instructions which, when executed by the processing circuitry, cause the coordinating entity to operate in accordance with claim 1.

17. A method for handling training of machine learning model, wherein the method is performed by a system comprising a plurality of network nodes and a coordinating entity that is operable to coordinate training of the machine learning model at one or more of the plurality of network nodes, wherein the method comprises:
the method as claimed in claim 1; and
a method performed by the first network node comprising:
in response to receiving the machine learning model from the coordinating entity:
training the machine learning model using training data that is available to the first network node.

18. A method as claimed in claim 17, the method performed by the first network node comprising:
continuing to train the machine learning model using the training data that is available to the first network node until a maximum accuracy for the trained machine learning model is reached and/or until the first network node runs out of computational capacity to train the machine learning model.

19. A method as claimed in claim 17, the method performed by the first network node comprising:
in response to receiving a request for the training data, wherein transmission of the request is initiated by the coordinating entity, initiating transmission of the training data towards the coordinating entity.

20. A method as claimed in claim 17, the method performed by the first network node comprising:
initiating transmission of the trained machine learning model towards the coordinating entity.

21. A method as claimed in claim 17, the method performed by the first network node comprising:
in response to receiving a request to trigger a transfer of the trained machine learning model from the first network node to the second network node:
initiating the transfer of the trained machine learning model from the first network node to the second network node for the second network node to further train the machine learning model.

22. A method as claimed in claim 17, wherein:
the training data that is available to the first network node comprises data from one or more devices registered to the first network node.

23. (canceled)

24. A computer program comprising instructions which, when executed by processing circuitry, cause the processing circuitry to perform the method according to claim 1.

25. A computer program product, embodied on a non-transitory machine-readable
medium, comprising instructions which are executable by processing circuitry to cause
the processing circuitry to perform the method according to claim 1.
